(19) United States
(12) Patent Application Publication
(10) Pub. No.: US 2016/0011039 A1
(43) Pub. Date: Jan. 14, 2016

(54) METHODS FOR DETERMINING THE PRESSURE TIME HISTORY OF A PRESSURE WAVE AS IT UNDERGOES FOCUSING

(71) Applicant: Gulfstream Aerospace Corporation, Savannah, GA (US)

(72) Inventors: Joseph A. Salamone, III, Savannah, GA (US); Victor W. Sparrow, University Park, PA (US); Kenneth J. Plotkin, Arlington, VA (US)

(73) Assignee: Gulfstream Aerospace Corporation, Savannah, GA (US)

(21) Appl. No.: 14/095,515

(22) Filed: Dec. 3, 2013

Related U.S. Application Data
(60) Provisional application No. 61/732,508, filed on Dec. 3, 2012.

(51) Int. Cl. G01H 5/00

(52) U.S. Cl. CPC G01H 5/00

(57) ABSTRACT

A method for determining a pressure time history of a pressure wave originating from a vehicle traveling at or above supersonic speeds when the pressure wave undergoes a focusing due to convergence and intersection with a neighboring pressure wave originating from the vehicle is disclosed herein. The method includes, but is not limited to, solving a lossy nonlinear Tricomi equation with a processor and reporting an output from the processor containing a solution to the lossy nonlinear Tricomi equation. The lossy nonlinear Tricomi equation includes a variable relating to an actual atmospheric dissipative effect in a vicinity of the focusing. The solution includes, but is not limited to, a prediction of the pressure time history of the pressure wave as the pressure wave undergoes focusing. The prediction reflects the actual atmospheric dispersive and dissipative effects.

### PRIORITY CLAIM

This application claims the benefit of co-pending U.S. Provisional Patent Application 61/732,508, filed 3 Dec. 2012 and entitled “Solution of the Lossy Nonlinear Tricomi Equation with Application to Sonic Boom Focusing”, which is hereby incorporated herein by reference in its entirety.

### TECHNICAL FIELD

The present invention generally relates to supersonic flight and more particularly relates to a method for determining a pressure time history of a pressure wave originating from a vehicle traveling at or above supersonic speeds when the pressure wave undergoes a focusing due to convergence and intersection with a neighboring pressure wave originating from the vehicle.

### BACKGROUND

The acceleration and turning maneuvers performed by vehicles travelling at supersonic speeds generate caustic surfaces that cause amplification of the propagating waves. These caustic surfaces often reach the ground and can lead to much greater acoustic pressure amplitudes than the sonic booms generated from a vehicle cruising at a steady supersonic trajectory. An additional source of increased acoustic pressure amplitude can occur because of how the rays in the wavefronts converge as a result of the maneuver, causing the ray tube area to decrease compared to the ray tube area of an aircraft travelling in a steady supersonic trajectory. That is, even though the rays have not reached the focus, waves undergo “focusing” as they approach the caustic due to the larger Blohkintzev invariant scaling factor. This increase in acoustic pressure is amplified even further once propagated into the caustic. Thus, it is important to quantify the effects of sonic boom focusing at a caustic to understand the overall amplification caused by unsteady aircraft maneuvers at supersonic speeds.

Focusing at the ground is unavoidable for any supersonic vehicle that accelerates to a speed greater than the cutoff Mach number. During an acceleration maneuver, a caustic surface is created at the vehicle the instant its speed becomes supersonic. The Mach cone of the vehicle becomes steeper as it continues to accelerate. A continuum of rays produced by the vehicle is launched normal to the Mach cone. Thus, portions of the wavefront generated later continually overtake portions of the wavefront generated at an earlier instant causing neighboring rays to converge and intersect. The caustic surface is formed at locations where the continuous convergence of rays occurs as the wavefront propagates away from the accelerating supersonic vehicle.

FIG. 1. Illustrates two-dimensional wavefronts propagated to the ground in a standard atmosphere due to supersonic acceleration/steady Mach/deceleration at a constant flight altitude. A line 100 indicates the portion of the wavefront that has not propagated through a caustic. A dashed line 102 indicates the portion of the wavefront that has already passed through the caustic. The dashed line 104 indicates the caustic location during wavefront propagation to the ground.

FIG. 1 illustrates a two-dimensional snapshot of propagating wavefronts from numerical simulations generated by an accelerating supersonic vehicle traveling through the standard atmosphere. The plot shows a planar cut from the caustic and wavefront surfaces in the plane vertical to the ground. In this example, the aircraft had accelerated at a constant Mach rate from Mach 0.9 to 1.3, held steady at Mach 1.3 for 20 seconds, and decelerated at a constant Mach rate to Mach 0.9 while at a constant altitude of 45,000 ft. The wavefront represented by line 100 indicates the continuum of rays that have not passed through a caustic. Dashed line 102 indicates the continuum of rays that have already passed through the caustic. When the rays converge as the wavefront represented by line 100 propagates to the ground, the caustic surface is continuously formed as indicated by line 104. The shape and curvature of the wavefronts are due to the Mach rate of the aircraft and the speed of sound gradient in the atmosphere below the tropopause. The formation of the caustic is directly related to the aircraft trajectory and the atmospheric conditions. The amplitude at the caustic involves coupling between the caustic geometry parameters, the atmospheric conditions and the vehicle characteristics such as weight and shape. According to geometric acoustics, however, the amplitude would be infinite at the caustic. The caustic is located at the edge of the wavefield, violating the smooth gradient assumption of geometrical acoustics and making diffraction effects important. It is also important to note that the caustic itself is a byproduct of the mathematical approach when using geometric acoustics in describing the focusing physics. In the physical realm, the amplitude along the wavefront remains finite and also continuously and smoothly transitions from the illuminated region and into to the shadow zone due to diffraction.

In the past, attempts have been made to model sonic boom focusing (i.e., to predict a time pressure history of a pressure wave as it undergoes focusing) using the conventional nonlinear Tricomi equation which was derived to predict the acoustic field in the vicinity of a caustic. The theory and numerical implementation has been developed by Guiraud, Gill and Seebass, Plotkin, Auger and Coulouvrat, Kandil, and Sescu. Guiraud developed his well-known scaling law for the focusing amplitude of a step shock. Plotkin used this method and coded it into PCBoom for focus boom prediction. Auger and Coulouvrat developed the pseduospectral method for solving the nonlinear Tricomi equation. Their algorithm obtains a solution by adding an unsteady term and iterating in pseudotime with a split-step method. Nonlinear effects are solved in the time domain using a shock-capturing scheme and the diffraction effects are solved in the frequency domain. This method was later modified by Marchiano et al. by formulating the nonlinear Tricomi equation in terms of the acoustic potential and using the shock fitting method of Hayes et al. for solving the nonlinear term in their splitting method. Using the shock fitting method resulted in a significant improvement in reducing the number of iterations required to achieve a solution since their method was not constrained by a Courant-Friedrichs-Lewy (CFL) condition. Kandil closely replicated the results of Marchiano and Coulouvrat using a pseudospectral method and time domain finite differencing methods for his numerical implementation. More recently, Sescu solved the nonlinear Tricomi equation in conservative form using a weighted essentially non-oscillatory (WENO) scheme and a Galerkin method with a nonlinear limiting scheme to control the numerically induced oscillations that occur at sharp pressure gradients.

While these past attempts to model sonic boom focusing have been adequate, none of these past attempts have taken into consideration actual atmospheric dissipative effects on the pressure wave as it focuses. Accordingly, it would be desirable to predict/calculate the finite amplitudes at the caustic and to model the effects of diffraction in the acoustic pressure field at the caustic in a manner that takes actual atmospheric dissipative effects into consideration. It would further be desirable to provide a computer code that permits the computation of focus boom predictions that take atmospheric dissipative effects into consideration. Furthermore, other desirable features and characteristics will become apparent from the subsequent detailed description and the appended claims, taken in conjunction with the accompanying drawings and the foregoing technical field and background.

### BRIEF SUMMARY

Various methods for determining a pressure time history of a pressure wave originating from a vehicle traveling at or above supersonic speeds when the pressure wave undergoes a focusing due to convergence and intersection with a neighboring pressure wave originating from the vehicle are disclosed herein.

In a first non-limiting embodiment, the method includes, but is not limited to, solving a lossy nonlinear Tricomi equation with a processor. The method further includes, but is not limited to, reporting an output from the processor, the output containing a solution to the lossy nonlinear Tricomi equation. The lossy nonlinear Tricomi equation includes a variable relating to an actual atmospheric dissipative effect in a vicinity of the focusing. The solution includes, but is not limited to, a prediction of the pressure time history of the pressure wave as the pressure wave undergoes focusing. The prediction reflects the actual atmospheric dissipative effect.

In a second non-limiting embodiment, the method includes, but is not limited to receiving an input at a processor, the processor configured to solve a lossy nonlinear Tricomi equation. The method further includes, but is not limited to, solving the lossy nonlinear Tricomi equation with the processor. The method still further includes, but is not limited to, reporting an output from the processor, the output containing a solution to the lossy nonlinear Tricomi equation. The lossy nonlinear Tricomi equation includes a variable relating to an actual atmospheric dissipative effect in a vicinity of the focusing. The solution includes, but is not limited to, a prediction of the pressure time history of the pressure wave as the pressure wave undergoes focusing. The prediction reflects the actual atmospheric dissipative effect.

### BRIEF DESCRIPTION OF THE DRAWINGS

The present invention will hereinafter be described in conjunction with the following drawing figures, wherein like numerals denote like elements, and

FIG. 1 is a graph illustrating propagation of two-dimensional wavefronts;

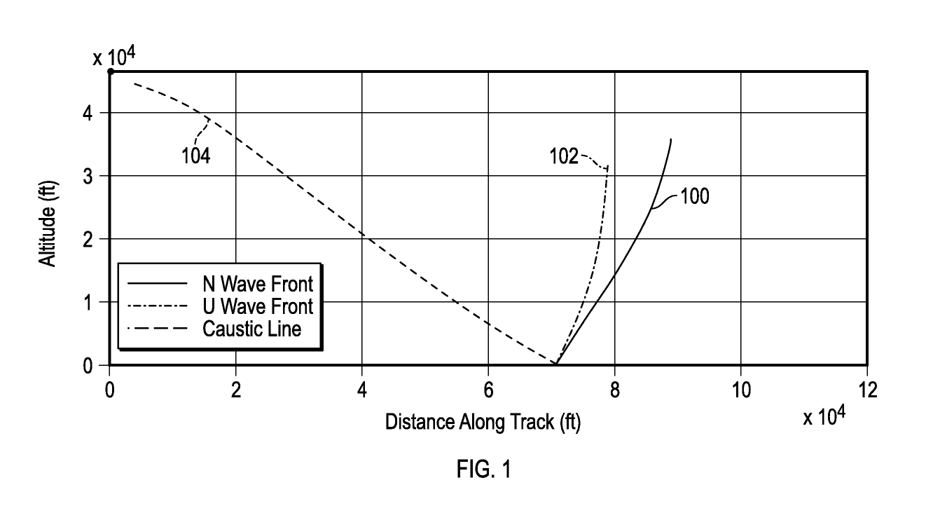

FIG. 2 is a graph illustrating a continuum of rays in a vicinity of a caustic;

FIG. 3 is a graph illustrating convergence monitoring as a function of pseudotime for four convergence parameters;

FIG. 4 contains multiple graphs illustrating the results of the Lossy Nonlinear Tricomi Equation code;

FIG. 5 contains multiple graphs illustrating the results of lossy nonlinear propagation of a sinusoid through a homogeneous medium with two relaxation processes;

FIG. 6 is a graph illustrating a comparison of the front shock from N-wave focusing;

FIG. 7 is a graph illustrating a comparison of the rear shock from N-wave focusing;

FIG. 8 is a graph illustrating a comparison of Lossy Nonlinear Tricomi Equation code solutions with losses versus without losses at a dimensionless Z location of 0.5;

FIG. 9 is a graph illustrating a comparison of Lossy Nonlinear Tricomi Equation code solutions with losses versus without losses at a dimensionless Z location of 0.15;

FIG. 10 is a graph illustrating sources of the acoustic input and caustic geometry for the Lossy Nonlinear Tricomi Equation code;

FIG. 11 is a graph illustrating an incoming N-wave form to the Lossy Nonlinear Tricomi Equation code;

FIG. 12 is a graph illustrating an exemplary pressure field solution from the Lossy Nonlinear Tricomi Equation;

FIG. 13 is a graph illustrating an exemplary Lossy Nonlinear Tricomi Equation prediction at a dimensionless Z location of 0.97 compared to a microphone measurement from the SCAMP flight test;

FIG. 14 is a graph illustrating an exemplary Lossy Nonlinear Tricomi Equation prediction at a dimensionless Z location of 0.67 compared to a microphone measurement from the SCAMP flight test;

FIG. 15 is a graph illustrating an exemplary Lossy Nonlinear Tricomi Equation prediction at a dimensionless Z location of 0.15 compared to a microphone measurement from the SCAMP flight test;

FIG. 16 is a graph illustrating an exemplary Lossy Nonlinear Tricomi Equation prediction at a dimensionless Z location of −0.22 compared to a microphone measurement from the SCAMP flight test; and

FIG. 17 is a flow diagram illustrating a non-limiting embodiment of a method for determining a pressure time history of a pressure wave as it focuses.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various symbols will be used herein. A summary explanation of those symbols are provided here:

p=acoustic pressure, Pa

f_{ac} =characteristic acoustic frequency, Hz

λ_{ac} =characteristic acoustic wavelength, m

p_{ac} =characteristic acoustic pressure, Pa

ε=dimensionless diffraction parameter

R_{cau} =radius of curvature of the line defined as the intersection of the caustic surface and the plane directed by both the tangent ray and the caustic normal, m

R_{ray} =radius of curvature of the ray tangent to the caustic, m

Rₜₒₜ =relative radius of curvature between the radius of curvature for the ray tangent to the caustic and the radius of curvature of the line defined as the intersection of the caustic surface and the plane directed by both the tangent ray and the caustic normal, m

d=diffraction boundary layer thickness, m

z̅=dimensionless distance from the caustic in the direction normal to the caustic

z=distance from the caustic in the direction normal to the caustic, m

x=distance from the caustic in the direction tangent to the caustic, m

t̅=dimensionless retarded time

t=time variable, s

σ̅=pseudotime variable

c₀=ambient speed of sound, m/s

ρ₀=ambient density, kg/m³

ρ=coefficient of nonlinearity

Mₓ=ratio of the wind speed, u_{0X}, in the direction tangent to the caustic to the ambient speed of sound

M_{z}=ratio of the wind speed, u_{0Z}, in the direction normal to the caustic to the ambient speed of sound

δ=diffusivity of sound, m²/s

mᵥ=dispersion parameter for the v-th relaxation component

τᵥ=relaxation time for the v-th relaxation component, s

c_{∞,v}=frozen speed of sound for the v-th relaxation component, m/s

The caustic is formed by rays whose ray tube area goes to zero and infinitesimally adjacent rays converge. In three dimensions, the caustic is a surface and in two dimensions the caustic is a line.

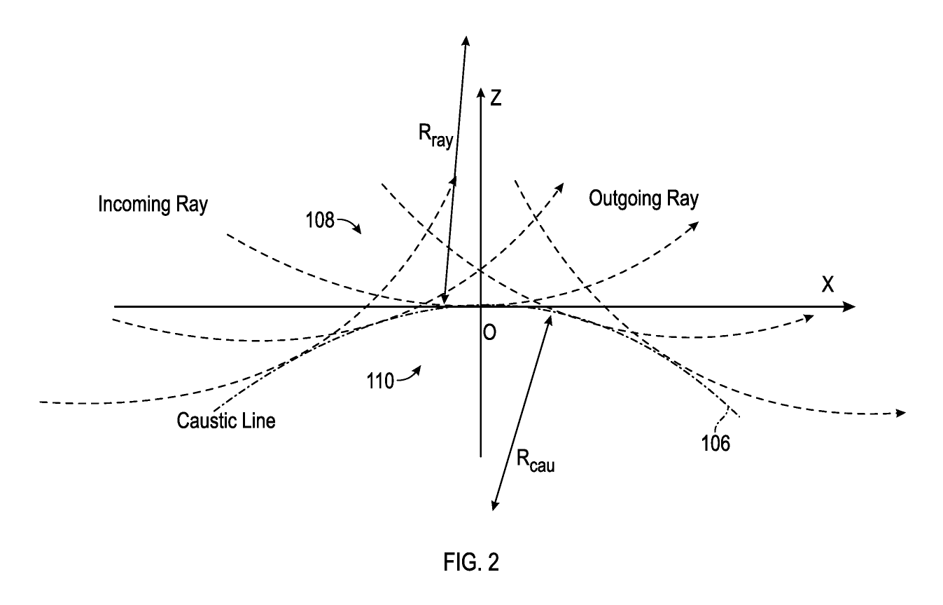

FIG. 2 illustrates the continuum of rays that propagate concavely upward and successively generate a caustic line 106 that is concave downward. The z-axis is normal to the caustic at point O, the x-axis is tangential to the caustic at point O and the y-axis is into the plane of the figure. Above caustic line 106, in a region 108 referred to as an illuminated zone, there are two rays that pass through each location—an incoming ray and an outgoing ray. The incoming ray has not yet passed through the caustic and the outgoing ray has already passed through the caustic. As an acoustic disturbance propagates along each ray and approaches the caustic, amplification and phase changes of the pressure waveform occur. The phase change contributes to transforming the classical “N” shape of a conventional sonic boom into a waveform shaped like a “U”. For the linear case, the “U” shape of the outgoing waveform is the result of a Hilbert transform of the incoming N-wave. Below caustic line 106 is region 110, referred to as a shadow zone. Geometric acoustics predicts that no rays pass into the shadow zone. In the physical world, however, sound does actually penetrate into the shadow zone due to diffraction. The result is an evanescent wave whose amplitude decays exponentially away from the caustic. Conventional ray theory is insufficient to predict the acoustic field in the diffraction region in the vicinity of the caustic in both regions 108 and 110, the illuminated zone and the shadow zone, respectively.

As shown in FIG. 2, a continuum of rays pass in the vicinity of caustic line 106. The rays refract upward due to a local speed of sound gradient. The illuminated zone (region 108) lies above the caustic. The shadow zone (region 110) lies below the caustic. The outgoing ray has already passed through the caustic. The incoming ray has not yet passed through the caustic.

The nonlinear Tricomi equation from the previous work of others has been augmented to include atmospheric loss mechanisms and an additional term to account for wind in the direction tangent to the caustic. The acoustic pressure perturbations and shocks in a sonic boom are typically modified due to the effects of absorption and dispersion as it propagates in the far-field from the vehicle in flight down to the caustic. Absorption due to the thermoviscous effects and molecular relaxation of oxygen and nitrogen in the atmosphere contributes to the finite rise time and thickness of shocks. Molecular relaxation effects cause dispersion, producing asymmetry in the shocks. The absorption and dispersion processes must be included in the incoming waveform to capture how they influence the acoustic pressure field near the caustic.

Below is presented an equation that may be used to determine the time pressure history of a pressure wave as it undergoes focusing:

$$\frac{{\partial }^{2} \overline{P}}{\partial {\overline{z}}^{2}} - \overline{z} \frac{{\partial }^{2} \overline{P}}{\partial {\overline{t}}^{2}} - 2 \frac{{M}_{z}}{ɛ} \frac{{\partial }^{2} \overline{P}}{\partial \overline{t} \partial \overline{z}} + ( \frac{2 {M}_{x}}{{ɛ}^{2}} - \frac{{M}_{x}^{2}}{{ɛ}^{2}} ) \frac{{\partial }^{2} \overline{P}}{\partial {\overline{t}}^{2}} + \frac{{β M}_{ac}}{{ɛ}^{2}} \frac{{\partial }^{2} {\overline{P}}^{2}}{\partial {\overline{t}}^{2}} + ( \frac{\overline{a}}{{ɛ}^{2}} + {\sum }_{v} \frac{\frac{{\overline{θ}}_{v}}{{ɛ}^{2}}}{1 + {\overline{τ}}_{v} \frac{\partial }{\partial \overline{t}}} ) \frac{{\partial }^{3} \overline{P}}{\partial {\overline{t}}^{3}} = 0 \qquad ( 1 )$$

The summation over v is from 1 to 2 for oxygen and nitrogen relaxation, p̅=p/p_{ac} is the dimensionless pressure, M_{ac}=p_{ac}/ρ₀c₀² is the characteristic acoustic Mach number and p_{ac} is the characteristic acoustic pressure which is usually specified as the peak pressure of the incoming waveform corresponding to a distance of one diffraction boundary layer thickness. The first two terms in Equation 1 account for diffraction and correspond to the linear Tricomi equation, the third term accounts for the z-component of wind, the fourth term accounts for the x-component of wind, the fifth term accounts for nonlinearity and the sixth term accounts for thermoviscous absorption and molecular relaxation due to oxygen and nitrogen. This equation shall be referred to herein as the “lossy nonlinear Tricomi equation” or “LNTE”.

Auger's derivation of his lossless nonlinear Tricomi equation provides an explanation to support the assumption that the diffraction in the y-direction is negligible, which is typically valid when the x̅- z̅ plane coincides in the region of the zero-degree azimuth from underneath the supersonic vehicle. It also assumes the propagation through the caustic occurs in a preferred direction along the x̅-axis and, consequently, the x̅-direction terms have been put in terms of the dimensionless time variable. The dimensionless time variable that includes the eikonal function is defined as:

$$\overline{t} = {f}_{ac} [ t - \frac{x ( 1 - z / {R}_{cau} )}{{c}_{0}} ] \qquad ( 2 )$$

The eikonal function used here was obtained by analyzing the local caustic geometry in terms of curvilinear coordinates. There are similar derivations for determining a suitable eikonal function. The eikonal function used here was version derived by Auger in his PhD thesis. The diffraction parameter is defined as

$$ɛ = \frac{{λ}_{ac}}{d} = {{λ}_{ac} [ \frac{{R}_{tot} {c}_{0}^{2}}{2 {f}_{ac}^{2}} ]}^{- \frac{1}{3}} = {[ \frac{2 {λ}_{ac}}{{R}_{tot}} ]}^{\frac{1}{3}} \qquad ( 3 )$$

ε is a ratio of the characteristic acoustic wavelength, λ_{ac}, to the diffraction boundary layer thickness, d. The total relative radius of curvature is

$$\frac{1}{{R}_{tot}} = \frac{1}{{R}_{cau}} - \frac{1}{{R}_{ray}}$$

(see FIG. 2). The dimensionless distance to the caustic is defined by

$$\overline{z} = {z [ \frac{2 {f}_{ac}^{2}}{{R}_{tot} {c}_{0}^{2}} ]}^{\frac{1}{3}} \qquad ( 4 )$$

This is the distance away from the caustic in the direction normal to the caustic divided by the diffraction boundary layer thickness. The normalized component of wind in the x- and z-directions are defined as M_{X}=/u_{0X}/c₀ and M_{Z}=u_{0Z}/c₀, respectively. The dimensionless thermoviscous absorption and dispersion coefficients are given by α̅=δf_{ac}/c₀² and θ̅ᵥ= τ̅ᵥmᵥ=f_{ac}τᵥ(c_{∞,v}²−c₀², respectively, and the dimensionless relaxation time is τ̅ᵥ=f_{ac}τᵥ [24]. The absorption and dispersion terms are newly added terms in the nonlinear Tricomi equation to model the acoustic field near a caustic. Comparison of the relative orders of magnitudes of the terms as presented in Equation 1 reveals that the loss terms are several orders of magnitude lower than the diffraction terms, nonlinear term and wind terms when ranked in magnitude according to the diffraction parameter, ε. However, the terms that include absorption and dispersion also contain a third-derivative with respect to time and, as a consequence, in the frequency domain would grow in proportion to frequency cubed. The frequency range of interest here (up to 10 kHz) is 10 to 20 times higher than the frequency range of interest from the work of previous authors. Thus, when high frequency signal content is present in certain parts of the waveform (such as the shocks in N-waves) the loss terms can reach within one to two orders of magnitude of the diffraction and nonlinear terms. A strong motivating factor for including the loss terms is it is well understood that high frequency content, manifested in the shocks, can have an important impact on perceptual metrics of sonic booms used for subjective evaluation. Modeling the shocks as accurately as possible is important to permit accurate assessments of how “loud” a focus boom will sound to human observers.

The time-wise boundary conditions assume that the waveform is undisturbed for both large negative and large positive time, which is interpreted as:

p̅( t̅→±∞, z̅)=0 (5)

The pressure field decays exponentially and goes to zero as z̅ approaches negative infinity. For the domain that extends infinitely away from the caustic, the boundary condition is:

p̅( t̅, z̅→−∞)=0 (6)

With continuing reference to FIG. 2, as one moves away from the caustic along the positive 7-axis the solution must match the incoming and outgoing rays from geometric acoustics. That is, the Tricomi formulation in the vicinity of the caustic must also match the pressure field consisting of an incoming ray and an outgoing ray when there is sufficient distance away from the caustic. The boundary condition for the positive z̅-axis becomes

p̅( t̅, z̅→∞)≈ z̅^{-1/4}└F( t̅+2/3 z̅^{3/2})+G( t̅−2/3 z̅^{3/2})┘ (7)

where F is the incoming waveform and G is the outgoing waveform, both of which have been normalized by the characteristic acoustic pressure, p_{ac}. The complication with Equation 7 being that only the incoming wave, F, is known and G is unknown. In the literature, the boundary condition for large, positive z̅ can be written as a radiation condition only in terms of F.

$${\overline{z}}^{1 / 4} \frac{\partial \overline{p}}{\partial \overline{t}} + {\overline{z}}^{- 1 / 4} \frac{\partial \overline{p}}{\partial \overline{z}} + {\overline{z}}^{- 5 / 4} \frac{\overline{p}}{4} = 2 {F}^{′} ( \overline{t} + \frac{2}{3} {\overline{z}}^{3 / 2} ) \qquad ( 8 )$$

where the prime symbol applied to F refers to a derivative with respect to its argument.

The numerical solution to Equation (1) includes newly added terms to account for the loss mechanisms and the x-wind term. A pseudotime variable, σ̅, and unsteady term were added to Equation (1). The equation implemented in the numerical algorithm to solve the LNTE was

$$\frac{{\partial }^{2} \overline{p}}{\partial \overline{t} \partial \overline{σ}} = \frac{{\partial }^{2} \overline{p}}{\partial {\overline{z}}^{2}} - \overline{z} \frac{{\partial }^{2} \overline{p}}{\partial {\overline{t}}^{2}} - 2 \frac{{M}_{z}}{ɛ} \frac{{\partial }^{2} \overline{p}}{\partial \overline{t} \partial \overline{z}} + ( \frac{2 {M}_{x}}{{ɛ}^{2}} - \frac{{M}_{x}^{2}}{{ɛ}^{2}} ) \frac{{\partial }^{2} \overline{p}}{\partial {\overline{t}}^{2}} + \frac{β {M}_{ac}}{{ɛ}^{2}} \frac{{\partial }^{2} {\overline{p}}^{2}}{\partial {\overline{t}}^{2}} + ( \frac{\overline{α}}{{ɛ}^{2}} + {\sum }_{v} \frac{\frac{{\overline{θ}}_{v}}{{ɛ}^{2}}}{1 + {\overline{τ}}_{v} \frac{\partial }{\partial \overline{t}}} ) \frac{{\partial }^{3} \overline{p}}{\partial {\overline{t}}^{3}} \qquad ( 9 )$$

As the computations converge towards the numerical solution, the unsteady term on the left hand side of Equation (9) tends towards zero and the desired solution to the LNTE is achieved. In some embodiments, an approach to solving Equation (9) is a splitting method that solves for the diffraction terms, the nonlinear term and the absorption/dispersion terms in separate steps. The nonlinear term is solved in the time domain and the linear terms are solved in the frequency domain. The frequency domain steps are solved for each harmonic component. The time domain step is solved for each z̅ coordinate. The discretized computational domain in both the z̅- and t̅-directions have uniform spacing.

The upper and lower boundary conditions must be modified accordingly to be consistent in both the frequency domain and time domain and also be suitable for a computational domain of finite extent. The boundary condition in Equation (8) becomes

$$\frac{\partial {\hat{p}}_{n}}{\partial \overline{z}} + ( i {ω}_{n} {\overline{z}}_{max}^{1 / 2} + \frac{{\overline{z}}_{max}^{- 1}}{4} ) {\hat{p}}_{n} = {\overline{z}}_{max}^{1 / 4} 2 i {ω}_{n} exp ( \frac{2}{3} i {ω}_{n} {\overline{z}}_{max}^{3 / 2} ) {\hat{F}}_{n} \qquad ( 10 )$$

The boundary condition in Equation (10) is applied at the maximum z̅ location, z̅ₘₐₓ, in the computational domain, typically at z̅ₘₐₓ=1 which corresponds to one diffraction boundary layer thickness. \hat{p}ₙ is the n-th harmonic of the pressure field at a particular z̅-coordinate, which in the case of the above boundary condition is z̅ₘₐₓ. \hat{F}ₙ is the n-th harmonic of the FFT of the incoming waveform, F, and ωₙ is the n-th harmonic of the dimensionless angular frequency. The z̅ derivative in Equation (10) is discretized to second order.

For the lower boundary condition, the solution to the lossless, windless, linear Tricomi equation includes an asymptotic expression for the Airy function. The spectral solution of the linear Tricomi equation is:

$$\begin{matrix}{\hat{p}}_{n} ( \overline{z} ) = \sqrt{2 π} [ 1 + i sgn ( {ω}_{n} ) ] {\vert {ω}_{n} \vert}^{1 / 6} Ai ( - {\vert {ω}_{n} \vert}^{2 / 3} \overline{z} ) {\hat{F}}_{n} & ( 11 a ) \\ Ai ( ξ \to ∞ ) \approx \frac{exp ( - \frac{2}{3} {ξ}^{3 / 2} )}{2 \sqrt{π} {ξ}^{1 / 4}} & ( 11 b )\end{matrix}$$

where sgn is the signum function, Ai is the Airy function and ξ is the argument of the Airy function. Equations 11a and 11b were combined and manipulated to obtain the boundary condition for the lower part of the computational domain:

$$\frac{\partial {\hat{p}}_{n}}{\partial \overline{z}} - ( \frac{1}{4} {\vert {\overline{z}}_{min} \vert}^{- 1} + \vert {ω}_{n} \vert {\vert {\overline{z}}_{min} \vert}^{1 / 2} ) {\hat{p}}_{n} = 0 \qquad ( 12 )$$

As in Equation (10), Equation (12) is applied for each harmonic component, n. The z̅ derivative in Equation (12) is discretized to first order. The lower edge of the boundary condition typically extends to a minimum z̅ location of z̅ₘᵢₙ=−1. The boundary condition in Equation (12) is different than what has been specified previously where p̅( t̅, z̅ₘᵢₙ)=0 for the minimum z̅ boundary location. The disadvantage to using that boundary condition is the z̅ₘᵢₙ=−1 pressure amplitudes are typically not close enough to zero for that approximation to be valid in a finite computational domain. Applying a zero pressure-amplitude at that location will influence the pressure amplitudes in the vicinity of the caustic leading to underestimated values for the pressure. The z̅ₘᵢₙ value should be at least 2 in order to avoid underestimating the pressure amplitudes near the caustic, leading to a considerably larger computational domain when using a p̅( t̅, z̅ₘᵢₙ)=0 boundary condition. Thus, as also mentioned by Auger in his PhD thesis, it is more computationally efficient and more accurate to use the linear Tricomi solution instead of a zero-pressure value for the boundary condition at z̅ₘᵢₙ.

The first step in the computational process transforms the pressure field to the frequency domain via Fast Fourier Transform (FFT) and then solves for the diffraction and z-wind component terms.

$$i {ω}_{n} \frac{\partial {\hat{p}}_{n}}{\partial \overline{σ}} = {ω}_{n}^{2} \overline{z} {\hat{p}}_{n} + \frac{{\partial }^{2} {\hat{p}}_{n}}{\partial {\overline{z}}^{2}} - i {ω}_{n} \frac{2 {M}_{z}}{ɛ} \frac{\partial {\hat{p}}_{n}}{\partial \overline{z}} \qquad ( 13 )$$

Equation (13) is solved using a fully implicit numerical discretization scheme that is second order in space and first order discretization in pseudotime. The corresponding boundary conditions are Equations (10) and (12). The solution for Equation (13) is determined for each harmonic component, n, of the pressure field. Next, the x-wind, absorption and dispersion terms are solved in the second step.

$$i {ω}_{n} \frac{\partial {\hat{p}}_{n}}{\partial \overline{σ}} = - {ω}_{n}^{2} ( \frac{2 {M}_{x}}{{ɛ}^{2}} - \frac{{M}_{x}^{2}}{{ɛ}^{2}} ) {\hat{p}}_{n} - i {ω}_{n}^{3} ( \frac{\overline{α}}{{ɛ}^{2}} + {\sum }_{v} \frac{{\overline{θ}}_{v} / {ɛ}^{2}}{1 + i {ω}_{n} {\overline{τ}}_{v}} ) {\hat{p}}_{n} \qquad ( 14 )$$

Equation (14) is solved using an exact solution. This is a computational step not performed by previous authors of sonic boom focusing work because the terms are newly derived for this invention. In the third step, an inverse FFT is applied to the pressure field and the nonlinear step is solved using:

$$\frac{\partial \overline{p}}{\partial \overline{σ}} = \frac{β {M}_{ac}}{{ɛ}^{2}} \frac{\partial {\overline{p}}^{2}}{\partial \overline{t}} \qquad ( 15 )$$

Equation (15) is solved using an exact solution at each F location and is different from the methods used by other authors when solving the nonlinear Tricomi equation. The physical dimensionless time base is adjusted according to the Poisson solution and is linearly interpolated back to the uniform time base.

The pseudotime step size is chosen using the criteria by Cleveland for the splitting method in his thesis. The pseudotime increment value is applied equally for each of the above three computational steps describing Equations (13) to (15). The numerical shock “distance,” which in this case the “distance” is the pseudotime, is calculated for each z̅ location. The pseudotime step increment is chosen to be 1/10^{th} the minimum shock “distance” calculated from the entire solution domain. As a result, the pseudotime step increment can vary from one iteration to the next depending on the magnitude of pressure gradients in the solution. The approach here for determining the pseudotime step increment to account for the nonlinear solution step is conservative. This method, in conjunction with the step that accounts for absorption and dispersion, is an attempt to best preserve the resolution of any shocks that might develop as a result of focusing.

The above three steps from Equations (13) to (15) are repeated iteratively until convergence is achieved. The starting pressure field is zero. The code iterates to determine the linear Tricomi solution, then uses the linear solution as the initial guess to iterate towards the solution of the lossy nonlinear Tricomi equation. The iterative convergence of the solution is monitored in several ways as the pressure field evolves in pseudotime. The code performs a global search over all of the z̅ locations and determines the z̅-coordinate that shows the largest change in pressure value during the nonlinear solution step for all of the time-values at that z̅-coordinate. The convergence parameter for that z̅ location is the maximum difference in the solution between the current and the next iterations divided by the pseudotime step size. The normalization by the pseudotime step size was chosen because the pseudotime increment can vary and the solution difference per unit pseudotime places the amount of change per iteration in the same relative value from one iterative step to the next. Additionally, the code also performs a global search over all of the ω frequencies and finds the frequency with the largest change in spectral amplitude during the diffraction solution step for all of the z̅ locations at that frequency. The convergence parameter for that ω frequency is the maximum difference in the solution from the current iteration to the next iteration, again normalized by the pseudotime step increment, for the spectral amplitudes at that ω for all of the corresponding z̅ locations. An additional convergence parameter corresponds to the top edge of the domain to monitor the evolution of the outgoing waveform. The convergence parameter for the z̅ₘₐₓ location is the maximum value of the difference of the solution at z̅ₘₐₓ between the current and previous iterations divided by the pseudotime step size. Lastly, the pseudotime step value itself is a convergence parameter that correlates to the largest slope in the solution domain. For the nonlinear solution step, the pseudotime step increment is determined based on a search for the maximum pressure gradient, with respect to dimensionless time, in the solution. Thus, the stabilization of the pseudotime step increment as the solution is iterated is also an indicator for convergence since it represents how the maximum slope in the solution domain evolves in pseudotime.

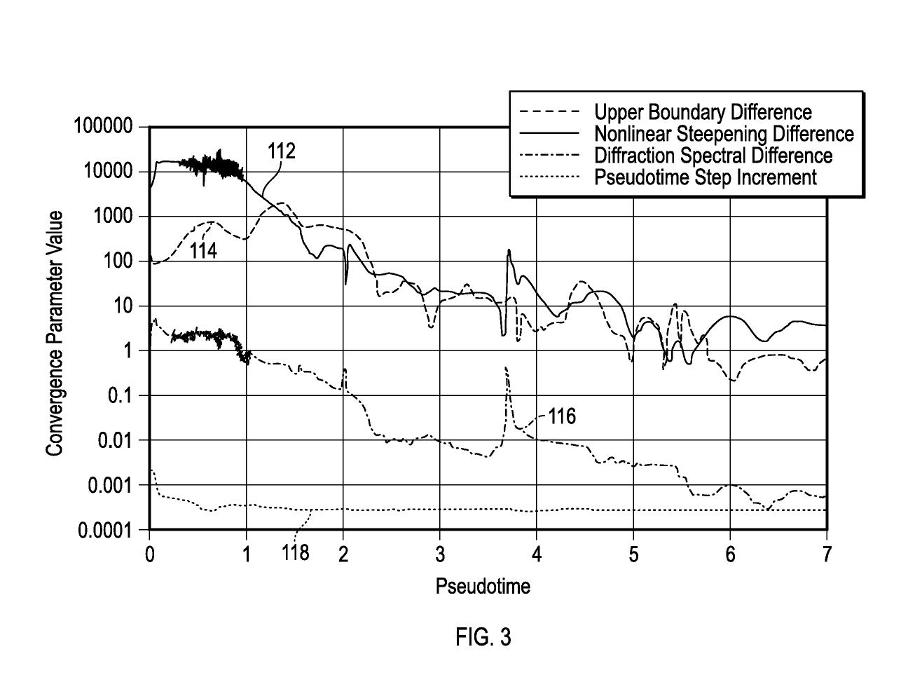

An example of convergence monitoring using these parameters is given in FIG. 3. In FIG. 3, convergence monitoring as a function of pseudotime for the four convergence parameters is illustrated. Observe that the upper boundary difference 112, the nonlinear steepening difference 114 and the diffraction spectral difference 116 all reduce by four orders of magnitude and level off after a pseudotime of 6. The pseudotime step increment 118 remains fairly constant after a pseudotime of 5.

The values for these convergence parameters reduce in value by four orders of magnitude after a pseudotime value of 7 over the course of approximately 23,000 iteration steps. The convergence parameter values shown in FIG. 3 correspond to the experimental validation case described below.

Two numerical validation tests were performed for the coded implementation of the LNTE. The first check examines the ability of the code to model the diffraction effects. The second check examines the code's ability to model the nonlinear, absorption and dispersion effects. The first check compared the computational output from the code to the analytical solution of the linear Tricomi equation by only enabling the diffraction effects in the computer code. The second check compared the computational output of the code to a spectral solution of lossy nonlinear propagation of a sinusoid in a homogenous medium. This check was accomplished numerically by disabling the diffraction effects in the code and retaining the nonlinear, absorption and dispersion effects.

The first numerical validation compares the analytical solution for the linear Tricomi equation to the LNTE computation with only the diffraction effects enabled in the code. The time-domain version of the analytical solution was obtained from the expression in:

p̅( t̅, z̅)=IFFT(\sqrt{2π}[1+i sgn(ω]|ω|^{1/6}Ai(−|ω|^{2/3} z̅)\hat{F}) (16)

where ‘IFFT’ is the inverse Fourier transform, sgn is the signum function and Ai is the Airy function.

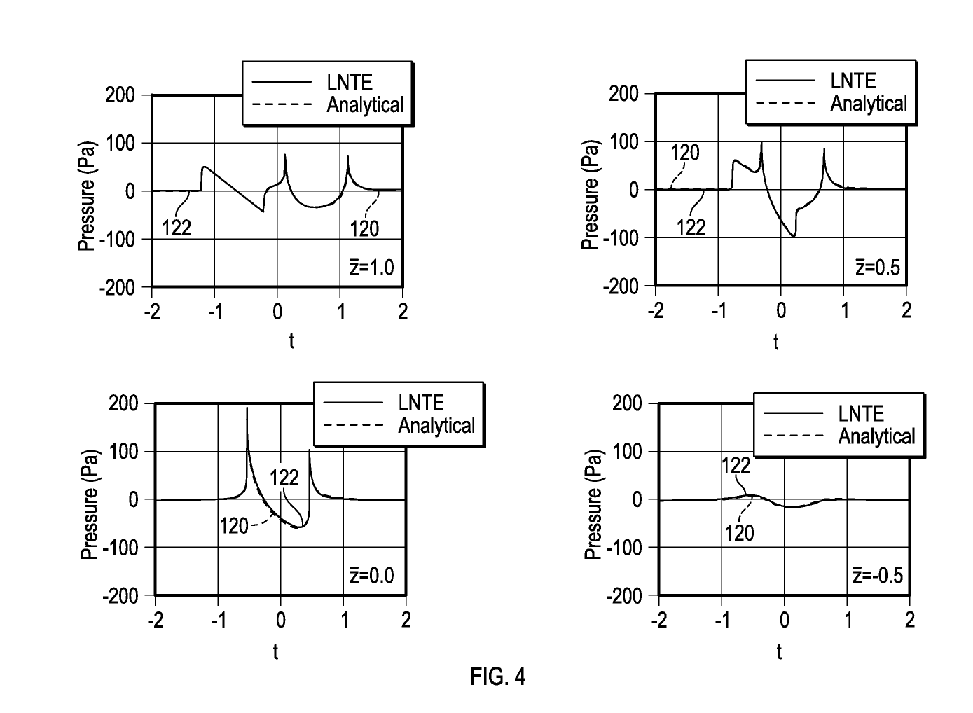

The comparison plots illustrated in FIG. 4 show the results of the diffraction numerical validation at four different z̅ locations. FIG. 4 illustrates the results of the LNTE code with only the diffraction terms included in the computations (dotted line 120) compared to the analytical solution of the lossless linear Tricomi equation (line 122) at four different z̅ locations: a) z̅=1.0, b) z̅=0.5, c) z̅=0. and d) z̅=−0.5.

An N-wave with finite rise time at the shocks was used as the incoming waveform. The incoming N-wave had a characteristic pressure of 50 Pa and a waveform duration of 0.3 seconds. The agreement is very good in the illuminated zone (the two upper graphs illustrated in FIG. 4), the shadow zone (the lower right hand graph illustrated in FIG. 4) and on the caustic line (the lower left hand graph illustrated in FIG. 4).

The second validation check examines the lossy nonlinear propagation of a sinusoid through a homogeneous medium. This situation can be adequately modeled by a lossy Burgers equation. A spectral solution for this appears in the nonlinear acoustics book edited by Hamilton and Blackstock. They solve the Burgers equation in the frequency domain for a finite number of harmonics using a Runge-Kutta scheme. This is the same numerical check Cleveland used to validate his code that implements the augmented Burgers equation; however, the Hamilton-Blackstock solution is stated for only one relaxation process. Applicant modified this to include two relaxation processes for numerical validation of his augmented KZK code.

$$\begin{matrix}\frac{d {\tilde{p}}_{n}}{d \overline{σ}} = \frac{2 β {M}_{ac}}{{ɛ}^{2}} \frac{i {\overline{ω}}_{n}}{4} ( {\sum }_{m = 1}^{n - 1} {\tilde{p}}_{m} {\tilde{p}}_{n - m} + 2 {\sum }_{m = n + 1}^{M} {\tilde{p}}_{m} {\tilde{p}}_{m - n}^{*} ) - ( {A}_{n} + {iD}_{n} ) {\tilde{p}}_{n} & ( 17 a ) \\ {A}_{n} = \frac{{\overline{ω}}_{n}^{2}}{{ɛ}^{2}} ( \overline{α} + {\sum }_{v} \frac{{\overline{θ}}_{v}}{1 + {( {\overline{ω}}_{n} {\overline{τ}}_{v} )}^{2}} ) & ( 17 b ) \\ {D}_{n} = - \frac{{\overline{ω}}_{n}^{3}}{{ɛ}^{2}} {\sum }_{v} \frac{{\overline{θ}}_{v} {\overline{τ}}_{v}}{1 + {( {\overline{ω}}_{n} {\overline{τ}}_{v} )}^{2}} & ( 17 c )\end{matrix}$$

In this case, the dimensionless angular frequency is ω̅ₙ=2πf₀n/f_{ac}, f₀ is the fundamental frequency of the initial sinusoid, Aₙ is the absorption coefficient, Dₙ is the dispersion coefficient and \tilde{p}ₙ is the complex pressure at the n-th harmonic, for n=1..M harmonics. The ambient pressure, temperature and relative humidity were 101.325 kPa, 284.5 K, and 70%, respectively, for this numerical validation. The initial sinusoidal amplitude, p_{ac}, was 12.09 Pa and had a total of M=100 harmonics. The total relative radius of curvature was 40,000 meters.

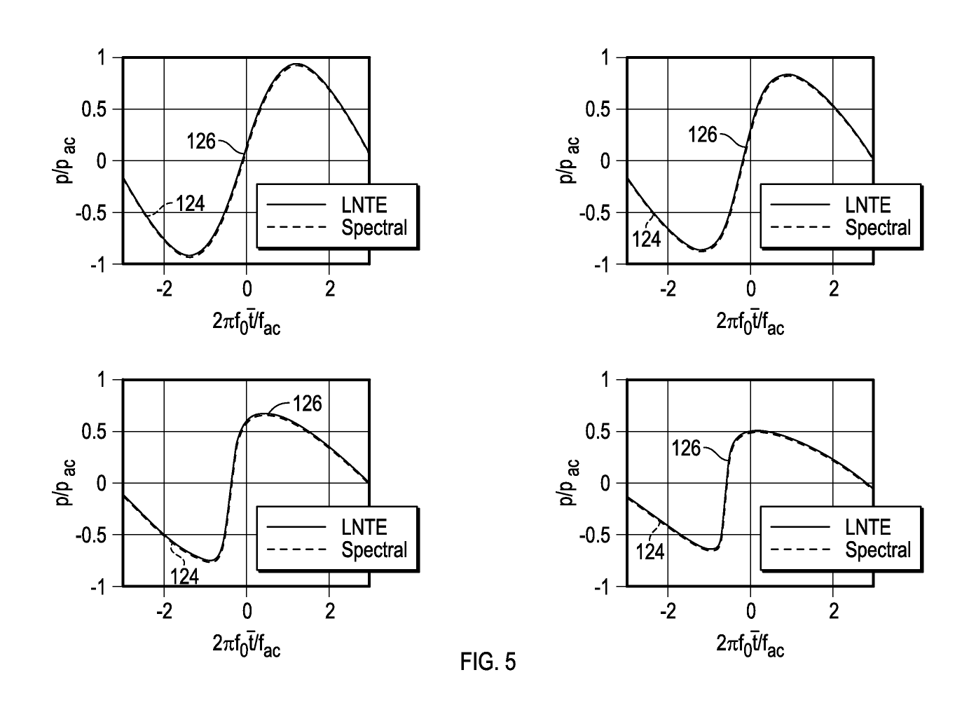

FIG. 5 shows comparisons between the spectral solution 124 (the dashed lines) and the numerical propagation 126 from the LNTE code (solid line) at four different pseudotimes. FIG. 5 illustrates the results of lossy nonlinear propagation of a sinusoid through a homogeneous medium with two relaxation processes. The LNTE code output (numerical propagation 126) is compared to a spectral solution (spectral solution 124) from equation 16 after propagation for a pseudotime of four different shock formation “distances”. The upper left plot is a shock formation “distance” of 0.5, pseudotime of 0.1131. The upper right plot is a shock formation “distance” of 1.0, pseudotime of 0.2266. The lower left plot is a shock formation “distance” of 2.0, pseudotime of 0.4525. The lower right plot is a shock formation “distance” of 3.0, pseudotime of 0.6788.

For this numerical validation the pseudotime variable represents a propagation “distance” variable. The pseudotimes for each plot in FIG. 5 corresponded to a series of lossless shock formation “distances”, where one shock formation “distance” in this formulation corresponds to the pseudotime value it would take for a shock to form in the absence of losses. From the top row to the bottom row starting at the upper left corner, the plots correspond to shock formation “distances” of 0.5, 1.0, 2.0, and 3.0, respectively, equal to pseudotime values of 0.1131, 0.2266, 0.4525 and 0.6788. The agreement is very good between the spectral solution and the LNTE output for all four cases.

A check was also performed to examine the influence of grid discretization on the numerical solution for N-wave focusing. The characteristic acoustic frequency, z̅ and z̅ₘₐₓ were held constant at 8.174 Hz, −1.0, and 1.0, respectively. The total relative radius of curvature, ambient pressure, temperature and relative humidity were also held constant at 48,769 meters, 91.3 kPa, 284 K and 40%, respectively. Table 1 summarizes the grid parameters that were varied to verify the solution converges towards a solution as the grid resolution is increased. The first column of Table 1 was the sample rate in dimensional units of the t̅-axis and the incoming N-wave which had a characteristic acoustic pressure of 57 Pa. The second column was the number of points in the z̅-axis. The third column was the number of points in the t̅-axis, which was always a power of two due to the FFT component of the numerical implementation. The next two columns are the d z̅ and d t̅ that pertain to the parameters in the first three columns. Each of the four solutions was determined by iterating to a pseudotime of 5.

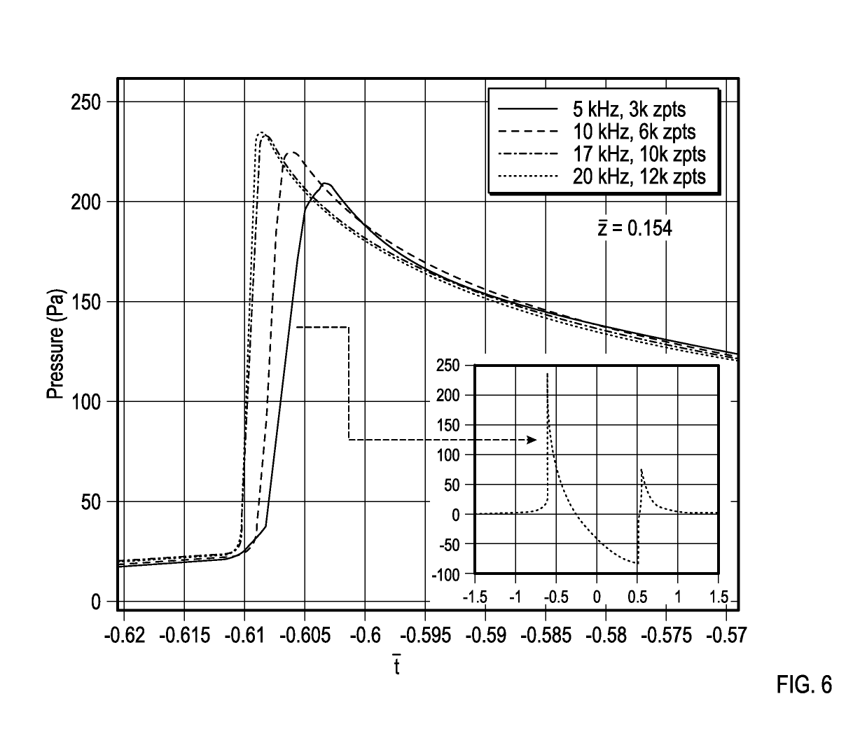

FIG. 6 illustrates a comparison of the front shock from N-wave focusing as the grid resolution is increased to finer values for the location corresponding to the maximum peak pressure of the front shock. The pressure peak and rise profile approach similar values as the grid density is increased. Specifically, FIG. 6 shows a comparison of the solutions from the four different grid resolutions that correspond to the z̅=0.154 location and closely zoomed in to the front shock. The z̅-coordinate was chosen because it was the highest pressure value found for the front shock in the solution at the highest grid resolution. The solutions approached a consistent peak pressure amplitude and rise profile as the grid resolution was refined to finer values.

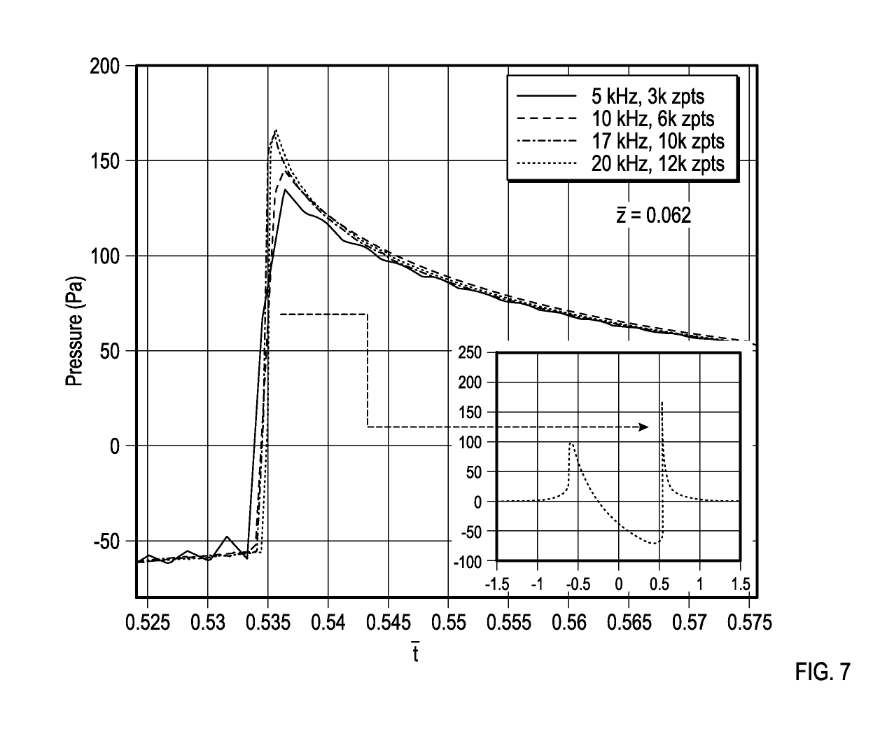

FIG. 7 Illustrates a comparison of the rear shock from N-wave focusing as the grid resolution is increased to finer values for the location corresponding to the maximum peak pressure of the rear shock. The pressure peak and rise profile reach similar values as the grid density is increased. Specifically, FIG. 7 shows a comparison of the same solutions for the same acoustic and caustic parameters and the same four grid resolutions as in Table 1 and FIG. 6, but is a close-up of the rear shock for the solution at the z̅=0.062 location. This z̅-coordinate corresponds to the location for the highest pressure peak for the rear shock at the highest grid resolution. Again, the solutions converge to a consistent peak amplitude and pressure rise as the grid resolution is improved. Additionally, the “Gibbs-like” oscillations just prior to the onset of the observed shock reduced in both FIGS. 6 and 7 as the grid resolution becomes finer.

TABLE 1
Parameters for demonstrating grid discretization convergence.

| sample rate | z-axis | time-axis | | |
|---|---|---|---|---|
| (kHz) | points | points | d z̅ | d t̅ |
| 5.120 | 3000 | 4096 | 0.000667 | 0.00160 |
| 10.240 | 6000 | 8192 | 0.000333 | 0.00080 |
| 17.067 | 10000 | 16384 | 0.000200 | 0.00048 |
| 20.480 | 12000 | 16384 | 0.000167 | 0.00040 |

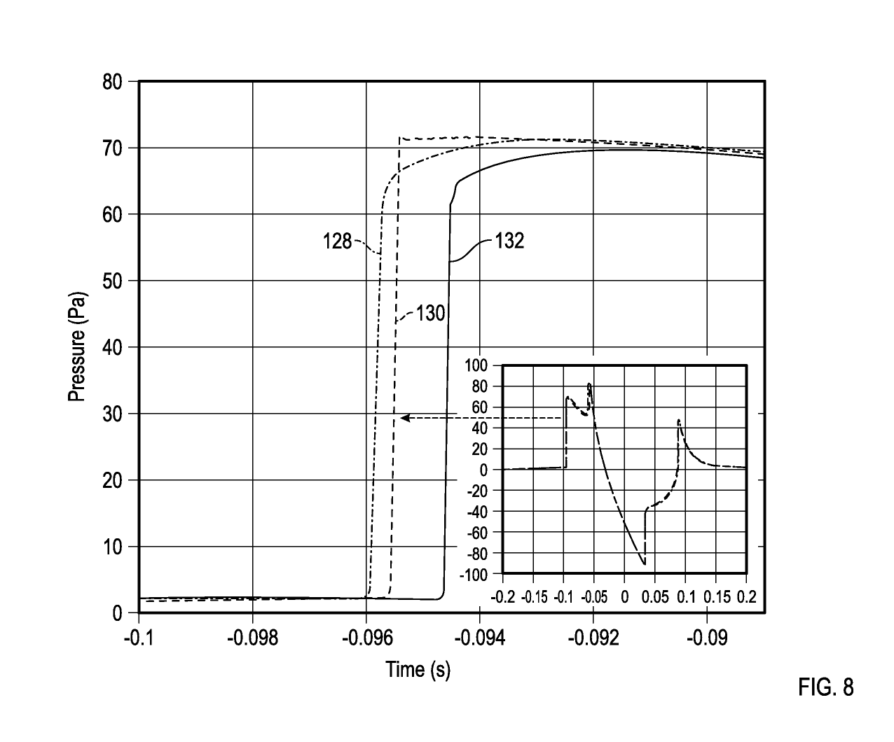

Lastly, comparisons were made between LNTE solutions with versus without the loss mechanisms included in the numerical computations. The motivation behind the comparisons was to illustrate the influence of the absorption and dispersion terms in equation 1 for an N-wave focusing case. FIG. 8 illustrates a comparison at z̅=0.5 of the LNTE code solutions with versus without losses included in the computational solution. Line 128 is the LNTE code with losses included and line 130 is the LNTE solution with the absorption and dispersion terms excluded in the numerical computations. Line 132 is the incoming N-wave scaled and phased according to Equation 7 for the function, F. FIG. 8 is a comparison of the LNTE solution with losses (line 128) versus without losses (130) at z̅=0.5 for the same highest resolution solution case from FIGS. 6 and 7. For reference, the incoming N-wave (line 132) is included in the comparison and was scaled and phased according to the incoming function, F, given in Equation 7. The distance of z̅=0.5 was chosen for the comparison because it is far enough from the caustic for the front part of the incoming N-wave to not show significant signs of amplification due to the focusing (matching with geometric acoustics), and also far enough from the upper boundary for lossy propagation effects to be observable. In FIG. 8, the LNTE solution with losses included in the numerical computations shows a front shock profile very similar to the incoming N-wave, which also included absorption and dispersion in its propagation. The “lossless” N-wave shock is noticeably steeper than the LNTE solution with losses. Thus, the loss terms in the LNTE maintain a shock profile for the N-wave in its solution that is consistent with the shock profile of the incoming N-wave.

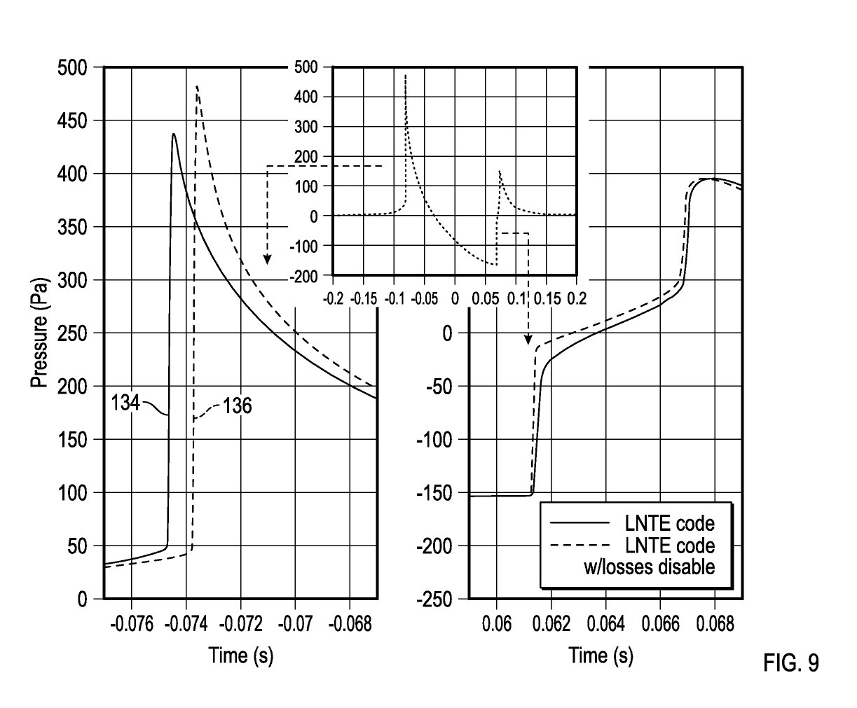

FIG. 9 illustrates a comparison at z̅=0.15 of the LNTE code solutions with versus without losses included in the computational solution. Line 134 is the LNTE code with losses included and line 136 is the LNTE solution with the absorption and dispersion terms excluded in the numerical computations. Specifically, FIG. 9 shows a comparison between the LNTE solution (line 134) and the “lossless” LNTE solution (line 136) at z̅=0.15 in the vicinity of the maximum peak pressure of the LNTE solution for the same case computed in FIG. 8. Observe that the front part of the waveform has a lower peak pressure but comparable rise times when the absorption and dispersion terms are included in the numerical solution. The comparison at the rear part of the waveform shows the “lossless” LNTE solution has shorter rise times and slightly higher pressure rises at the shocks than the LNTE solution. In examining both FIGS. 8 and 9, the “lossless” LNTE solutions show signs of numerical oscillations, so it is likely that including the loss mechanisms also provides some advantageous suppression of non-physical numerical oscillations. The comparison in FIG. 8 does show that the influence of the absorption and dispersion terms is consistent with the physics demonstrated in the shock profile of the incoming N-wave.

The SCAMP flight test successfully measured dozens of focus booms from a maneuvering NASA Dryden F-18. The main purpose of the SCAMP flight test was to conduct a flight test that provided measured data for the large-scale experimental validation of focus boom prediction codes. The ground array that captured the focus booms consisted of eighty one microphones linearly spaced over two-miles at the Cuddeback Gunnery Range, Calif. Trajectory information from the F-18 was simultaneously recorded to log the time-space data of the aircraft for synchronization with the acoustic measurement systems at the ground. Upper-air meteorological data was also captured by sounding the atmosphere with GPS-sonde weather balloons. Ground weather conditions were logged with weather stations. The combination of the aircraft position data, the upper-air meteorological data and ground weather data was used to facilitate focusing predictions at the ground.

Focus signatures in the SCAMP flight test were very consistent from pass to pass, tending to vary only for adverse atmospheric conditions. One particular test point, “maneuver C”, with the aircraft accelerating at a Mach rate of 0.0035 Mach/second and pushing downward at a pitch rate of −0.25 degrees/second, was in the middle of the overall test matrix. This maneuver (flight 1264, pass number 4) was selected for detailed comparisons with the LNTE predictions. Measured acoustic data from the other “maneuver C” flight passes under favorable atmospheric conditions would generally overlay with the selected pass.

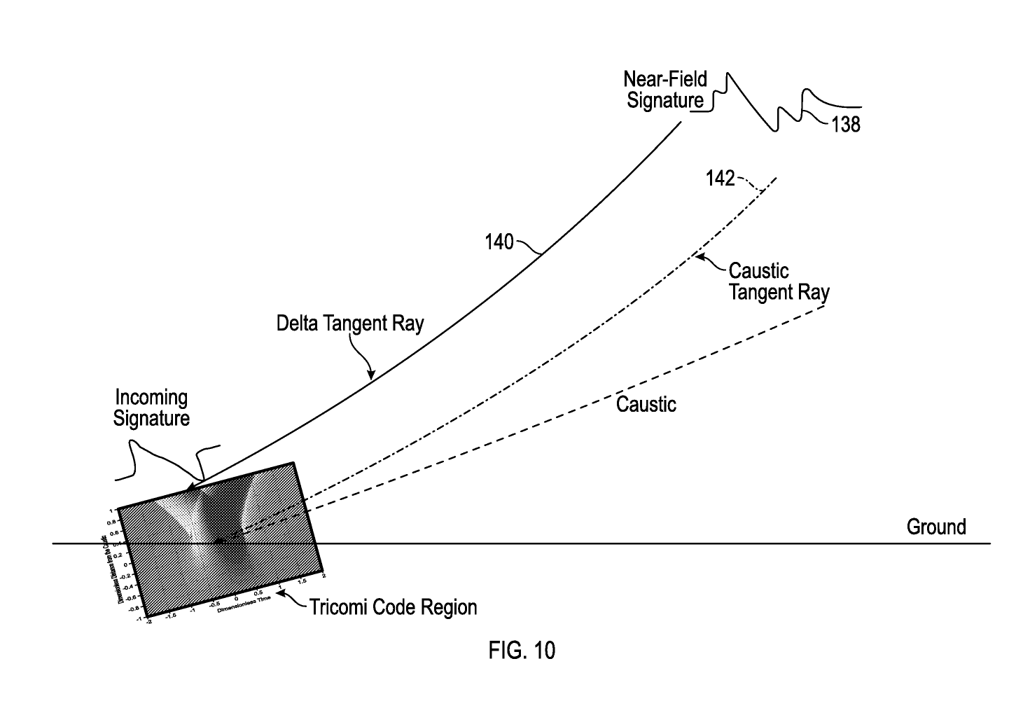

The predicted incoming waveform for the selected flight pass was obtained from PCBoom propagation down to a distance within one diffraction boundary layer thickness normal from the caustic intercept at the ground. The propagation from the near-field to the far-field included the same atmospheric loss mechanisms as Equation (1) and accounts for the ray tube area change resulting from a maneuvering supersonic aircraft relative to an aircraft at a steady supersonic trajectory. The near-field pressure waveform was obtained from CFD at the approximate altitude and Mach number that corresponded to the onset of the ray that was tangent to the caustic at the ground. This corresponds to flight conditions of a Mach number of 1.23, an altitude of 42,000 ft and an angle of attack of 2.3 degrees. The CFD was computed out to three body lengths and served as input to PCBoom. PCBoom computes focus points from a sequence of rays, and computes the radius of curvature by fitting a circle to those points. The rays are chosen such that they lie in a plane normal to the 3-D caustic surface. R_{cau} for use in LNTE is that at the caustic-ground intercept. This is shown in FIG. 10.

FIG. 10 illustrates sources of the acoustic input and caustic geometry for the LNTE code. A near-field CFD pressure signature 138 is propagated along a “delta tangent ray” 140 down to a distance of one diffraction boundary layer thickness from the caustic intercept at the ground. The caustic geometry is determined from a caustic tangent ray 142.

The ray curvature, R_{ray}, necessary to obtain Rₜₒₜ, is computed by fitting a circle to points along caustic tangent ray 142. The incoming waveform, caustic geometry at the ground intercept and the ground meteorological data were provided to the LNTE code by PCBoom as inputs to compute the focused pressure field at the ground for one of the SCAMP flight test passes.

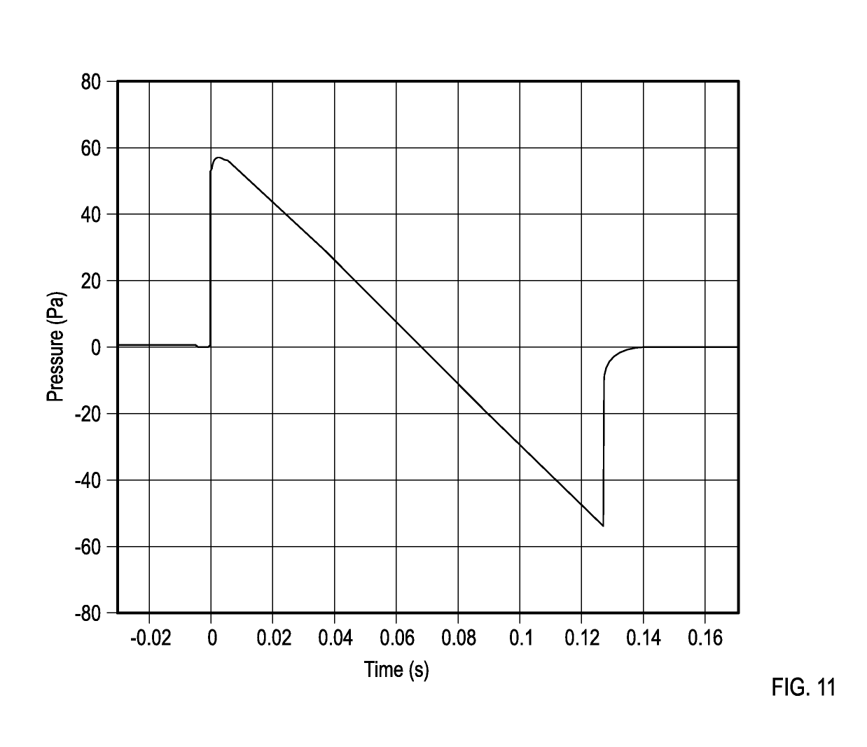

FIG. 11 is a plot of the incoming waveform that was the predicted output from PCBoom for flight number 1264, pass number 4 from the SCAMP test. The focusing parameters and conditions were a characteristic acoustic frequency of 8.17 Hz, a total relative radius of curvature of 48,769 meters, ambient temperature of 284 K, ambient pressure of 91.3 kPa, and relative humidity of 40%. Since there was no wind at the ground, the wind terms were omitted from the calculations. The computational domain extended from z̅ₘₐₓ=1 to z̅ₘᵢₙ =−1 with 12,000 points in the z̅-direction and 16,384 points in the t̅ direction at a dimensional sample rate of 20,480 Hz. The solution was iterated up to a pseudotime value of 7 (over 23,000 iteration steps). The convergence monitoring for the solution is the example shown in FIG. 3.

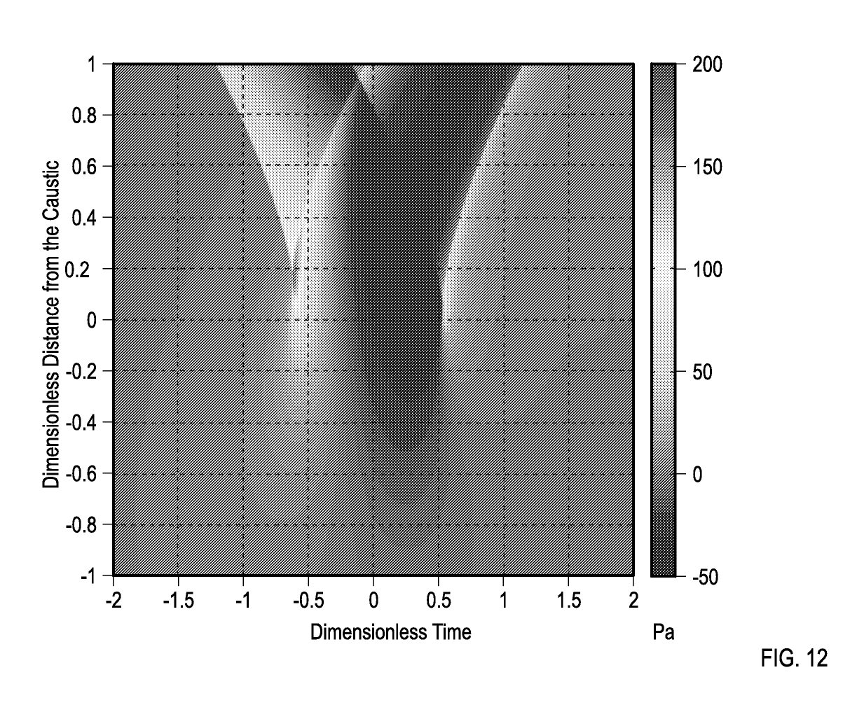

FIG. 12 illustrates the pressure field solution to the LNTE prediction for the NASA SCAMP test, flight 1264, pass 4. More generally, FIG. 12 shows the pressure contour of the LNTE predicted acoustic field. The upper left part of the solution shows the incoming N-wave propagating through to the caustic, the outgoing wave reflecting off of the caustic and propagating to the upper right part of the solution. Observe that the predicted peak pressure does not coincide with the z̅=0 location that geometric acoustics predicts, but instead is predicted to be located slightly above it for both the front and rear shocks.

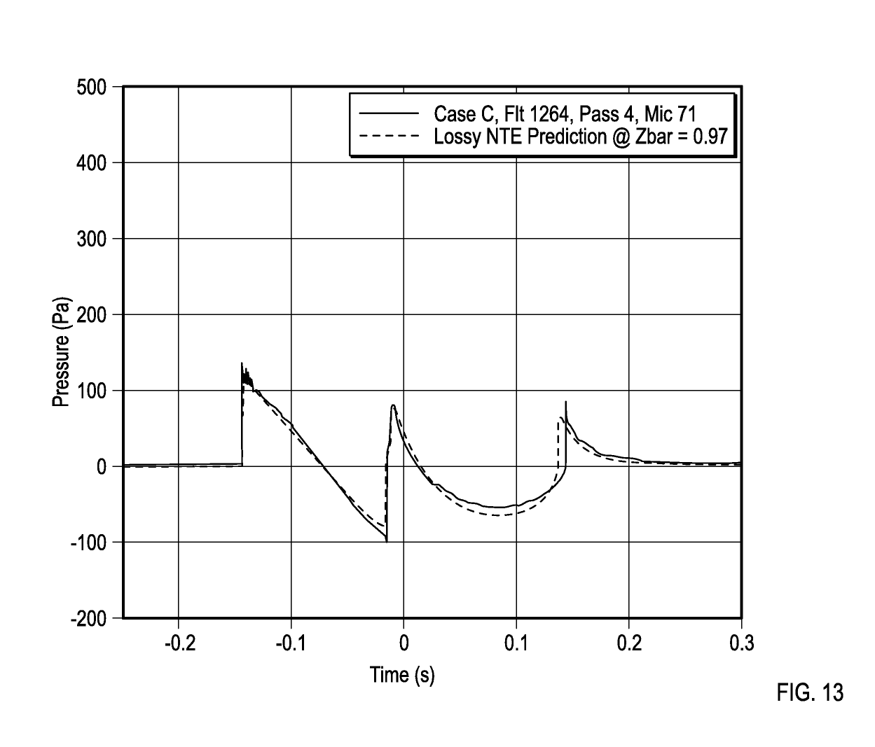

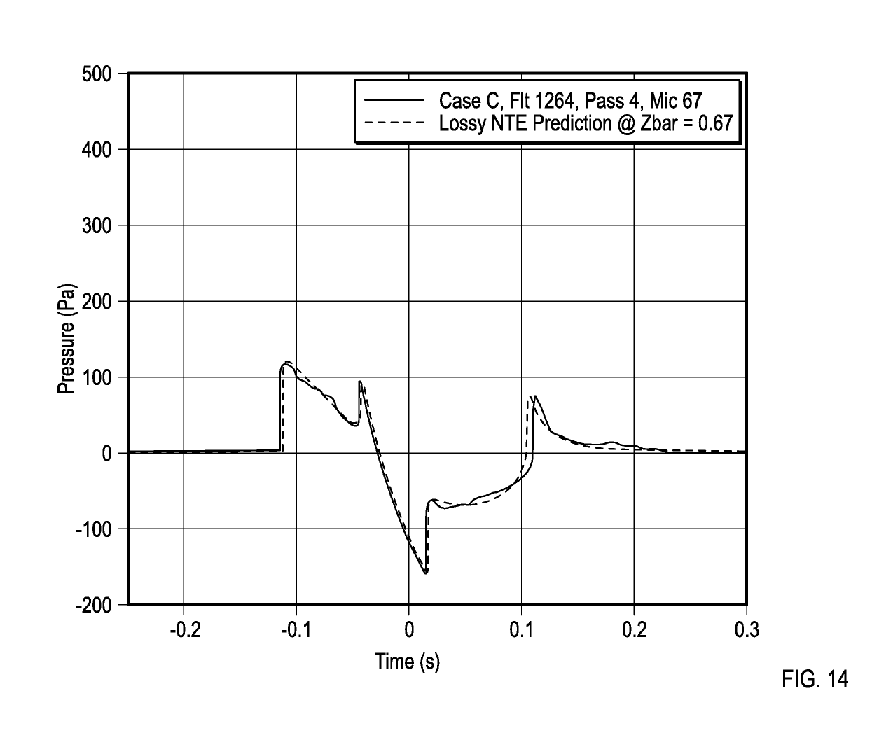

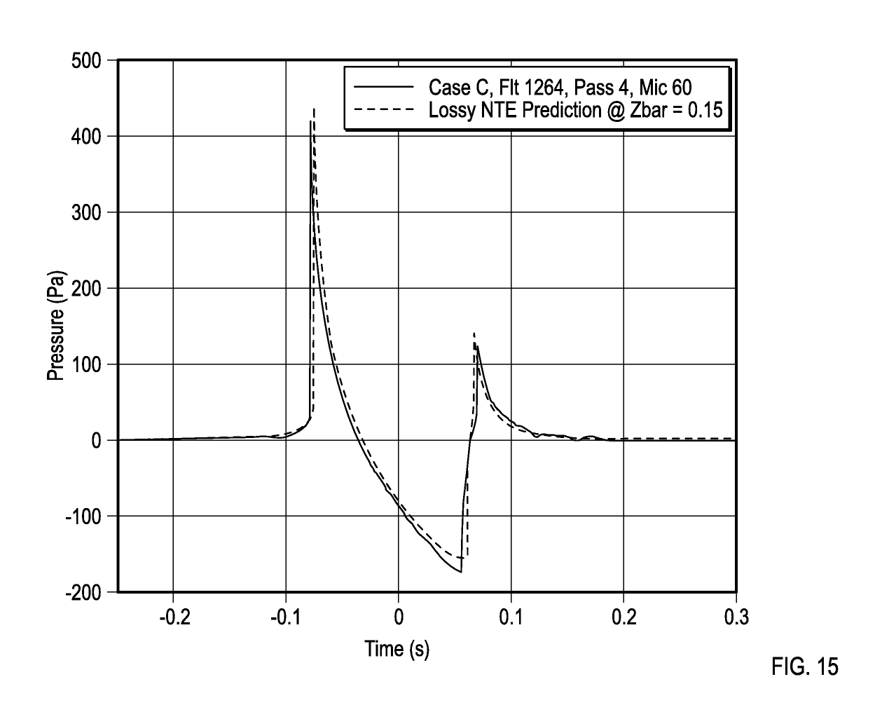

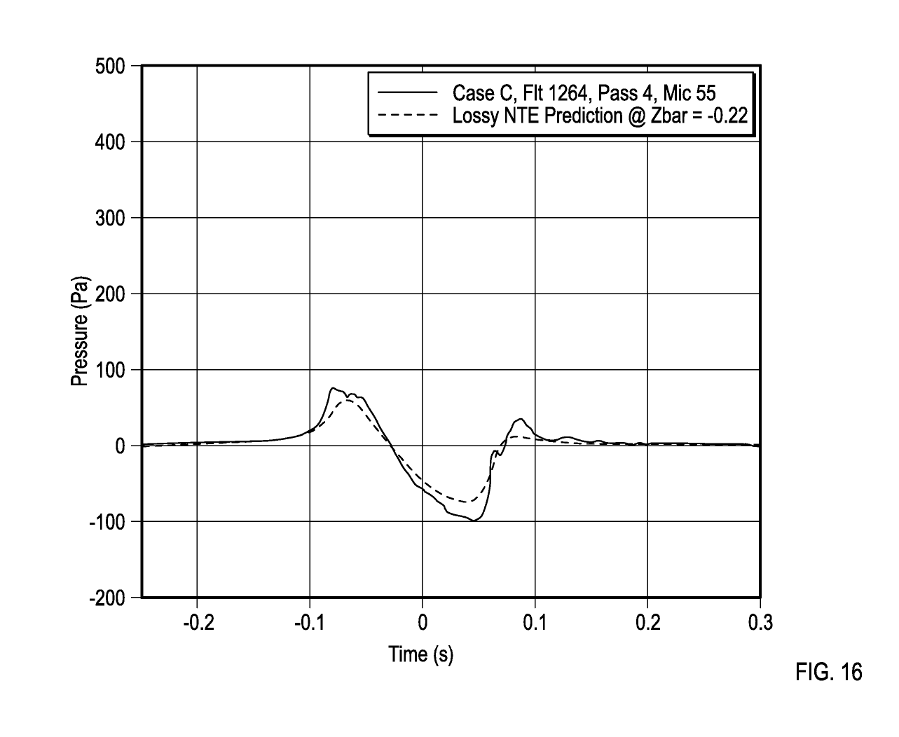

FIGS. 13-16 show a comparison of four of the microphone measurements to their respective LNTE predictions. FIG. 13 illustrates the LNTE prediction at z̅=0.97 compared to SCAMP flight test measurement at microphone 71. FIG. 14 illustrates the LNTE prediction at z̅=0.67 compared to SCAMP flight test measurement at microphone 67. FIG. 15 illustrates the LNTE prediction at z̅=0.15 compared to SCAMP flight test measurement at microphone 60. The microphone at this location measured the highest peak pressure from any of the microphones in the array for this flight pass. FIG. 16 illustrates the LNTE prediction at z̅=−0.22 compared to SCAMP flight test measurement at microphone 55.

With respect to FIGS. 13-16, the focus predictions have been multiplied by a scale factor of 1.9 to account for ground reflection. In principle, ground impedance effects should be accounted for when comparing predictions with ground measurements. However, for the SCAMP test, the microphones were not placed directly on the ground but instead were placed on ¾″-inch plywood boards that were wrapped by a thin plastic moisture barrier. The measurement site and ground boards presented a hard surface, for which the detailed effects of impedance on sonic boom amplitude tend to be small, so for the current analysis reflection was addressed by the traditional simple factor of 1.9. In FIG. 13, the LNTE prediction of the waveform duration for the incoming N-wave shows good agreement with the microphone measurement. The predicted amplitude is less than the measured data, but the mismatch in pressure levels can be attributed to the influence of atmospheric turbulence, which is not accounted for in the model equation. The predicted outgoing U-wave is in good agreement with the amplitude of the measured U-wave, but the predicted phase is slightly shorter than the measurement. In FIG. 14, the comparison between the LNTE prediction and the measured data shows good agreement for the incoming N-wave. The outgoing U-wave waveform period is slightly under-predicted by the LNTE code, but the amplitude of the U-wave is in good agreement. In FIG. 15, the comparison location corresponds to the microphone that measured the highest peak pressure for any of the microphones in the array for that flight pass. The prediction for the front shock slightly overestimates the peak amplitude. The LNTE predicts the two closely spaced rear shocks similar to what is observed in the measurement, except that the shock spacing predicted by the LNTE code is slightly less than what was measured. FIG. 16 is a comparison of the LNTE prediction to a microphone in the shadow zone. The LNTE prediction shows the amplitudes of positive and negative pressure peaks are less than the measured data, however, the predicted LNTE waveform period closely matches the measured data. It is likely that atmospheric turbulence in the microphone measurement caused some of the observed amplitude perturbations. Overall, there is strong agreement between the LNTE predictions and the microphone measurements at the four locations in the comparisons.

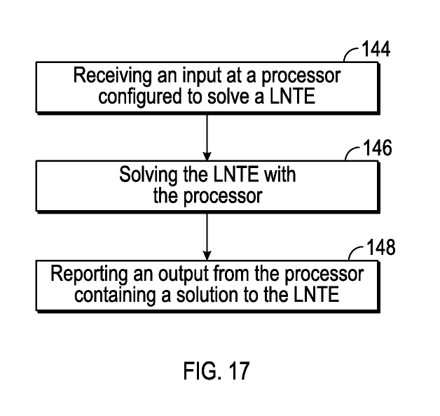

FIG. 17 illustrates a non-limiting embodiment of a method for determining a pressure time history of a pressure wave originating from a vehicle traveling at or above supersonic speeds when the pressure wave undergoes a focusing due to convergence and intersection with a neighboring pressure wave originating from the vehicle. At step 144, an input is received at a processor. The processor is configured to solve the Lossy Nonlinear Tricomi Equation (described in detail above).

In some embodiments, the input may comprise a time pressure history of the pressure wave at a predetermined location upstream of the focusing. In some examples, the location is one diffraction boundary layer thickness above the caustic. In some embodiments, the input may comprise a relative radius of curvature between the pressure wave and a caustic. In some embodiments, the input may comprise an atmospheric condition proximate the focusing. In some examples, the atmospheric condition may be measured at a ground surface, may be an ambient pressure proximate the focusing, may be an ambient temperature proximate the focusing; and/or may be a relative percent humidity proximate the focusing. In some embodiments, the input may comprise a distance between the pressure wave prior to focusing and a caustic. In some embodiments, the input may comprise a distance below the caustic. In an example, the distance below the caustic may be selected so as to account for substantially all of the diffraction effects arising out of the focusing. In some embodiments, the input may comprise a desired amount of discretization between a designated upper limit of a region proximate the focusing and a designated lower limit of the region proximate the focusing. In some embodiments, the input may comprise a desired sample rate along a time axis of the pressure time history of the pressure wave in a region of the focusing. In some embodiments, the input may comprise a wind speed. In an example, the wind speed may comprise a wind speed in an X direction with respect to the direction of the propagation of the pressure wave. In an example, the wind speed may comprise a wind in a Z direction with respect to a direction of the propagation of the pressure wave. In some embodiments, the input may comprise one, several, or all of the above mentioned inputs.

At step 146, the processor is used to solve the Lossy Nonlinear Tricomi Equation. The Lossy Nonlinear Tricomi Equation includes a variable that relates to an actual atmospheric dissipative effect in a vicinity of the focusing. In some embodiments, the variable relates to heat conduction. In some embodiments, the variable relates to viscosity. In some embodiments, the variable relates to molecular relaxation. In some examples, the variable relates to absorption caused by the molecular relaxation. In some examples, the molecular relaxation comprises relaxation of nitrogen molecules. In some examples, the molecular relaxation comprises relaxation of oxygen molecules. In some examples, the variable relates to dispersion caused by molecular relaxation. In some examples, he dispersion arises, at least in part, out of relaxation of nitrogen molecules. In some examples, the dispersion arises, at least in part, out of relaxation of oxygen molecules. In some embodiments, multiple variables are input corresponding to heat conduction, viscosity, and molecular relaxation, respectively.

At step 148, an output from the processor is reported. The output contains the solution to the Lossy Nonlinear Tricomi Equation determined by the processor. The solution is reflective of the actual atmospheric dissipative effect. In some embodiments, the output may take the form of a graph. In some embodiments, the graph may depict time along one axis, distance from the caustic along a second axis, and may depict the pressure of the pressure wave in a color coded manner.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for determining a pressure time history of a pressure wave originating from a vehicle traveling at or above supersonic speeds when the pressure wave undergoes a focusing due to convergence and intersection with a neighboring pressure wave originating from the vehicle, the method comprising:
solving a lossy nonlinear Tricomi equation with a processor; and
reporting an output from the processor, the output containing a solution to the lossy nonlinear Tricomi equation,
wherein the lossy nonlinear Tricomi equation includes a variable relating to an actual atmospheric dissipative effect in a vicinity of the focusing and wherein the solution comprises a prediction of the pressure time history of the pressure wave as the pressure wave undergoes focusing, and wherein the prediction reflects the actual atmospheric dissipative effect.

2. The method of claim 1, wherein the variable relates to heat conduction.

3. The method of claim 1, wherein the variable relates to viscosity.

4. The method of claim 1, wherein the variable relates to molecular relaxation.

5. The method of claim 4, wherein the variable relates to absorption caused by the molecular relaxation.

6. The method of claim 5, wherein the molecular relaxation comprises relaxation of nitrogen molecules.

7. The method of claim 5, wherein the molecular relaxation comprises relaxation of oxygen molecules.

8. The method of claim 4, wherein the variable relates to dispersion caused by the molecular relaxation.

9. The method of claim 8, where the dispersion arises, at least in part, out of relaxation of nitrogen molecules.

10. The method of claim 8, wherein the dispersion arises, at least in part, out of relaxation of oxygen molecules.

11. The method of claim 1, wherein the lossy nonlinear Tricomi equation includes a plurality of the variables, each of the variables relating to a respective actual atmospheric dissipative effect of a plurality of actual atmospheric dissipative effects in the vicinity of the focusing.

12. The method of claim 1, wherein the plurality of variables are reflective of heat conduction, viscosity, and molecular relaxation.

13. The method of claim 1, wherein the lossy nonlinear Tricomi equation comprises:
$$\frac{{\partial }^{2} \overline{p}}{\partial {\overline{z}}^{2}} - \overline{z} \frac{{\partial }^{2} \overline{p}}{\partial {\overline{t}}^{2}} - 2 \frac{{M}_{z}}{ɛ} \frac{{\partial }^{2} \overline{p}}{\partial \overline{t} \partial \overline{z}} + ( \frac{2 {M}_{x}}{{ɛ}^{2}} - \frac{{M}_{x}^{2}}{{ɛ}^{2}} ) \frac{{\partial }^{2} \overline{p}}{\partial {\overline{t}}^{2}} + \frac{β {M}_{ac}}{{ɛ}^{2}} \frac{{\partial }^{2} {\overline{p}}^{2}}{\partial {\overline{t}}^{2}} + ( \frac{\overline{α}}{{ɛ}^{2}} + {\sum }_{v} \frac{\frac{{\overline{θ}}_{v}}{{ɛ}^{2}}}{1 + {\overline{τ}}_{v} \frac{\partial }{\partial \overline{t}}} ) \frac{{\partial }^{3} \overline{p}}{\partial {\overline{t}}^{3}} = 0$$

14. A method for determining a pressure time history of a pressure wave originating from a vehicle traveling at or above supersonic speeds when the pressure wave undergoes a focusing due to convergence and intersection with a neighboring pressure wave originating from the vehicle, the method comprising:
receiving an input at a processor, the processor configured to solve a lossy nonlinear Tricomi equation;
solving the lossy nonlinear Tricomi equation with the processor; and
reporting an output from the processor, the output containing a solution to the lossy nonlinear Tricomi equation,
wherein the lossy nonlinear Tricomi equation includes a variable relating to an actual atmospheric dissipative effect in a vicinity of the focusing and wherein the solution comprises a prediction of the pressure time history of the pressure wave as the pressure wave undergoes focusing, and wherein the prediction reflects the actual atmospheric dissipative effect.

15. The method of claim 14, wherein the input comprises a time pressure history of the pressure wave at a predetermined location upstream of the focusing.

16. The method of claim 15, wherein the time pressure history of the pressure wave upstream of the focusing relates to a location that is one diffraction boundary layer thickness above a caustic.

17. The method of claim 14, wherein the input comprises a relative radius of curvature between the pressure wave and a caustic.

18. The method of claim 14, wherein the input comprises an atmospheric condition proximate the focusing.

19. The method of claim 18, wherein the atmospheric condition comprises an ambient pressure proximate the focusing.

20. The method of claim 18, wherein the atmospheric condition comprises an ambient temperature proximate the focusing.

21. The method of claim 18, wherein the atmospheric condition comprises a relative percent humidity proximate the focusing.

22. The method of claim 14, wherein the input comprises a distance between the pressure wave prior to focusing and a caustic.

23. The method of claim 14, wherein the input comprises a distance below the caustic.

24. The method of claim 14, wherein the input comprises a desired amount of discretization between a designated upper limit of a region proximate the focusing and a designated lower limit of the region proximate the focusing.

25. The method of claim 14, wherein the input comprises a desired sample rate along a time axis of the pressure time history of the pressure wave in a region of the focusing.

26. The method of claim 14, wherein the lossy nonlinear Tricomi equation comprises:
$$\frac{{\partial }^{2} \overline{p}}{\partial {\overline{z}}^{2}} - \overline{z} \frac{{\partial }^{2} \overline{p}}{\partial {\overline{t}}^{2}} - 2 \frac{{M}_{z}}{ɛ} \frac{{\partial }^{2} \overline{p}}{\partial \overline{t} \partial \overline{z}} + ( \frac{2 {M}_{x}}{{ɛ}^{2}} - \frac{{M}_{x}^{2}}{{ɛ}^{2}} ) \frac{{\partial }^{2} \overline{p}}{\partial {\overline{t}}^{2}} + \frac{β {M}_{ac}}{{ɛ}^{2}} \frac{{\partial }^{2} {\overline{p}}^{2}}{\partial {\overline{t}}^{2}} + ( \frac{\overline{α}}{{ɛ}^{2}} + {\sum }_{v} \frac{\frac{{\overline{θ}}_{v}}{{ɛ}^{2}}}{1 + {\overline{τ}}_{v} \frac{\partial }{\partial \overline{t}}} ) \frac{{\partial }^{3} \overline{p}}{\partial {\overline{t}}^{3}} = 0$$
